(19) United States
(12) Patent Application Publication
(10) Pub. No.: US 2018/0330217 A1
(43) Pub. Date: Nov. 15, 2018

(54) Electronic Vehicle Tag Collection System

(71) Applicant: BELAL KHADER, RALEIGH, NC (US)

(72) Inventor: BELAL KHADER, RALEIGH, NC (US)

(21) Appl. No.: 15/969,683

(22) Filed: May 2, 2018

Related U.S. Application Data
(60) Provisional application No. 62/505,225, filed on May 12, 2017.

(51) Int. Cl. G06K 19/07; B60R 13/10; G07C 5/00; H04W 4/029; H04W 4/44

(52) U.S. Cl. CPC G06K 19/0723; B60R 13/10; H04W 4/44; H04W 4/029; G07C 5/008

(57) ABSTRACT

An electronic vehicle tag collection system that provides a decal chip for a motor vehicle license plate registration tag that stores information of the registered motor vehicle and the owner and has notification and calling capabilities to activate itself and provide location of the vehicle. The device can also self-activate if the license plate is taken off the vehicle. This thin decal chip, comprising of a tiny GPS locator, will be programmed to communicate with local law enforcement and is capable of receiving and sending out updates and alerts from the authorities regarding amber alerts, all-points bulletins, person of interest and/or any traffic law violations committed by the driver or owner of the motor vehicle. It further provides a reader device with corresponding software that can be installed in an authorized vehicle of the law enforcement agencies and the corresponding software to receive updates and alerts from the decal chip.

### CROSS-REFERENCE TO RELATED APPLICATIONS

This application claims priority to and the benefit of U.S. Provisional Application No. 62/505,225 filed May 12, 2017 and entitled Electronic Vehicle Tag Collection System, the disclosure of which is hereby incorporated by reference in its entirety.

### FIELD OF THE INVENTION

The present invention relates generally to electronic vehicle identification and tracking systems. More particularly, the present invention pertains to license plate tags, methods of storing vehicle registration information and methods of transmitting vehicle registration information.

### BACKGROUND OF THE INVENTION

Most states in the United States of America require motor vehicle owners to register their motor vehicles periodically. During the registration process, small registration tags are issued by the state's department of motor vehicle licensing which are adhesively attached to the vehicle's license plate by the registered owner and/or driver. Local and/or state law enforcement can review the registration tags attached to the license plate of the vehicle to cross-check the information printed on the registration tags with the official information which can be obtained from the local law enforcement databases and the state's department of motor vehicle licensing databases. The process of cross-checking the registration information of the motor vehicle usually requires the law enforcement officer to personally look at the information printed on the license plate registration tags and to manually check if the motor vehicle's registration information is up to date and/or if the motor vehicle and/or the owner of the motor vehicle has any pending traffic law violations. The process may require a lengthy period of time and can distract the law enforcement officer from other duties while usually driving. In addition, current motor vehicle license plate registration tags lack the ability to receive updates and alerts from the authorities regarding amber alerts, all-points bulletins, person of interest, and/or any traffic law violations committed by the driver or owner of the motor vehicle.

Further, current motor vehicle license plate registration tags lack the ability to send out alerts to the law enforcement agencies regarding amber alerts, all-points bulletins, person of interest, and/or any traffic law violations committed by the driver or owner of the motor vehicle.

An objective of the present invention is to provide a decal chip for a motor vehicle license plate registration tag that can store all the information of the registered motor vehicle owner and the motor vehicle's information. Storing the motor vehicle's information and the registered motor vehicle owner's information in one place allows for easier and faster access and retrieval of useful information for the authorities and the law enforcement agencies. Another objective of the present invention is to provide a decal chip for a motor vehicle license plate registration tag which can receive updates and alerts from authorities and law enforcement agencies regarding amber alerts, all-points bulletins, person of interest, and/or any traffic law violations committed by the driver or owner of the motor vehicle. The ability to receive updates and alerts from the authorities allows law enforcement agencies to focus their actions on the motor vehicle of interest.

Another objective of the present invention is to provide a decal chip for a motor vehicle license plate registration tag that can send out updates and alerts to law enforcement agencies regarding amber alerts, all-points bulletins, person of interest, and/or any traffic law violations committed by the driver or owner of the motor vehicle. The ability to send updates and alerts to law enforcement agencies allows the law enforcement agencies to quickly respond to any emergency which can potentially save lives. Another objective of the present invention is to provide a reader device and the corresponding software that can be installed in an authorized law enforcement agency motor vehicle and can receive the updates and alerts from the decal chip on the motor vehicle license plate registration tag. A reader device and the corresponding software allows the law enforcement agent to receive updates and alerts from motor vehicles without having to manually check if the motor vehicles have committed any traffic law violations and/or are wanted for some official reason. Further, a reader device and the corresponding software allows law enforcement agencies to act faster and focus their approach on the correct target. Another objective of the present invention is to provide a system and method for monitoring and controlling traffic flow on roads, streets, and highways. The ability to monitor motor vehicles remotely and automatically allows authorities to check the state of the traffic flow on the roads, determine appropriate actions to alleviate or encourage the traffic flow, and consequently control the traffic flow on the roads. Additional advantages of the invention will be set forth in part in the description which follows, and in part will be obvious from the description, or may be learned by practice of the invention. Additional advantages of the invention may be realized and attained by means of the instrumentalities and combinations particularly pointed out in the detailed description of the invention section. Further benefits and advantages of the embodiments of the invention will become apparent from consideration of the following detailed description given with reference to the accompanying drawings, which specify and show preferred embodiments of the present invention.

### SUMMARY OF THE INVENTION

The present invention provides a decal chip for a motor vehicle license plate registration tag that stores the information of the registered motor vehicle and the registered motor vehicle's owner excluding the owner's social security number. The chip is comprised of a tiny global locator real time kit that runs off a super smart battery, or the car battery. Its size is very comparable to the current decals on tags. It will be programmed to communicate with the local law enforcement. The decal chip is capable of receiving and sending out updates and alerts from the authorities regarding amber alerts, all-points bulletins, person of interest and/or any traffic law violations committed by the driver or owner of the motor vehicle. The present invention further provides a reader device and the corresponding software to receive the updates and alerts from the decal chips. The reader device and the corresponding software can be installed in an authorized vehicle of the law enforcement agencies. The present invention provides a safer and quicker way for law enforcement agencies to retrieve useful information from a motor vehicle without having to manually cross-check the motor vehicle's information with official information obtained from local law enforcement agencies databases and the state's department of motor vehicle licensing databases. The present invention also provides a system and method of transmitting updates and alerts regarding amber alerts, all-points bulletins, person of interest and/or any traffic law violations committed by the driver or owner of the motor vehicle so the law enforcement can take faster action and take a more focused approach when an amber alert, an all-points bulletin, and/or a person of interest alert is issued which can potentially save lives. Further, the present invention provides a system and method to monitor and control traffic flow throughs pings, which in the context of this paper are signals which may include, but are not limited to, radio signals from the decal tag which are received by the one or more transmitter and one or more reader device. Numerous objects, features, and advantages of the present invention will be readily apparent to those of ordinary skill in the art upon a reading of the following detailed description of the presently preferred, but nonetheless illustrative, embodiment of the present invention when taken in conjunction with the accompanying drawings

### BRIEF DESCRIPTION OF THE DRAWINGS

FIG. 1 is a front plan view of the preferred embodiment of the present invention showing a decal tag with the registration information signage printed on the front cover and a plurality of solar cells placed around the front cover in a rectangular pattern along the edge of the decal tag.

FIG. 2 is a front plan view of the preferred embodiment of the present invention showing the inner circuit of the decal tag without the cover and showing the plurality of solar cells placed around the inner circuit in a rectangular pattern along the edge of the decal tag.

FIG. 3 is a schematic of an embodiment of the present invention in which information is transmitted to the decal tag from the one or more transmitter which then the decal tag sends out an alert to a law enforcement vehicle equipped with a reading device with the corresponding software.

### DETAIL DESCRIPTIONS OF THE INVENTION

All illustrations of the drawings are for the purpose of describing selected versions of the present invention and are not intended to limit the scope of the present invention. The present invention provides a decal tag, one or more transmitter and a reader device that allow authorities and law enforcement agencies to transmit updates and alerts to a decal tag which then sends out alerts to a reader device installed in a law enforcement motor vehicle.

Law enforcement agencies often have to manually cross-check information printed on the registration tags located on the license plates of motor vehicles in order to determine if the motor vehicle is wanted for an official reason or if the motor vehicle has any outstanding traffic law violations. Further, current registration tags lack the ability to receive and transmit updates and alerts regarding amber alerts, which is part of an emergency response system that disseminates information about a missing person, all-points bulletins, which are radio messages sent to officers in the law enforcement with details of a suspected criminal or stolen vehicle, person of interest, which is an individual involved in a criminal investigation who has not been arrested or formally accused of a crime, and any traffic violations committed by the owner of the motor vehicle or the driver, such as expired tags, unpaid traffic tickets, etc. Furthermore, current registration tags lack the ability to provide a method to determine a motor vehicle's location. Most related prior art disclose registration tags that can store the motor vehicle's registration information and the motor vehicle's registered owner information which can be read by a separate reader device. However, the present invention provides a registration tag that has the ability to receive updates and alerts and send out alerts to a reader device in addition to storing the motor vehicle's registration information and the motor vehicle's registered owner information. In addition, the present invention provides a method to locate the motor vehicle's position. These together with other objects and benefits of the invention, along with the various features of novelty that characterize the invention, are pointed out with greater particularity in the description below with the reference to the accompanying drawings.

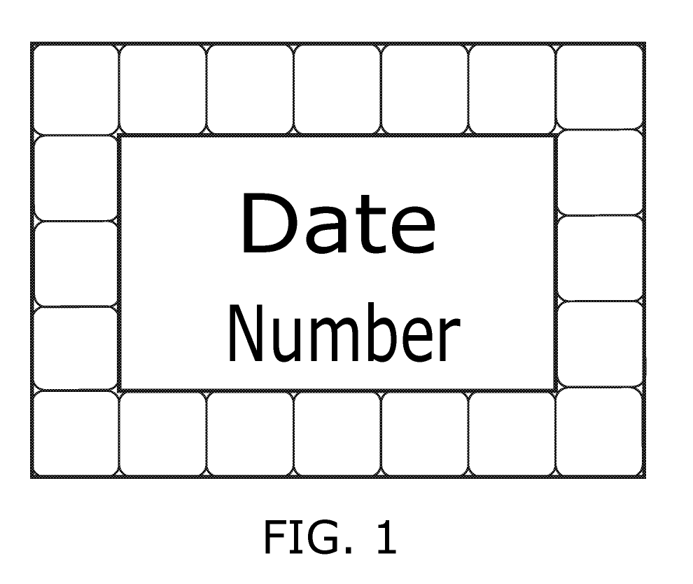

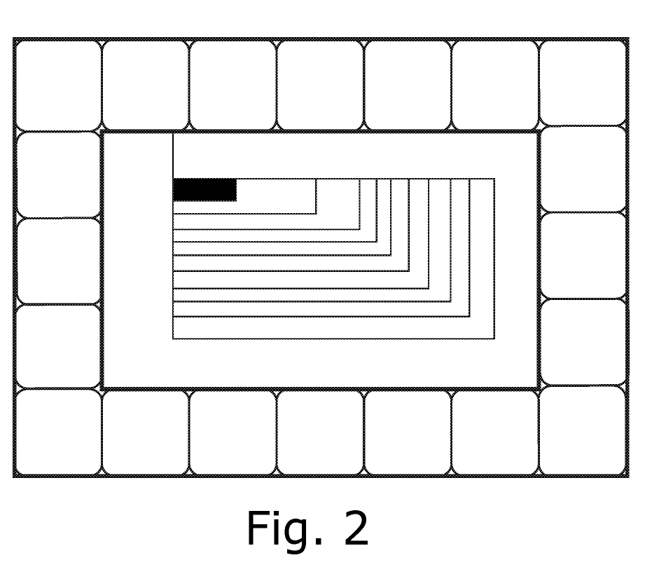

In the preferred embodiment of the present invention as shown in FIG. 1, the present invention comprises a decal tag, one or more transmitter, and a reader device. The decal tag further comprises a base, a circuit, a plurality of solar cells, a plurality of electronic components, a plurality of wires, a power storage unit, a cover, and a signage. The base further comprises an adhesive and an insulation. The circuit further comprises an antenna, a plurality of chips, a data storage unit, and a plurality of processors. The cover further comprises an adhesive and an insulation. The one or more transmitter further comprises an antenna, a power source, a power storage unit, a data storage unit, and a plurality of electronic components. The reader device further comprises a software, a display, a user interface, a power storage unit, a power source, and a plurality of electronic components. The software further comprises a decryption code. As can be seen in FIG. 2, the circuit contains the antenna, plurality of chips, the data storage unit, and the plurality of processors. The circuit is attached to the front face of the base. In the preferred embodiment of the present invention, the circuit is soldered onto the front face of the base. In alternate embodiments of the present invention, the circuit and the circuit components are glued or fastened to the front face of the base. The base has a back face with a layer of insulation and an outer layer of adhesive. In the preferred embodiment of the present invention, the base is made from a semi-flexible material that can insulate the circuit, e.g. durable vinyl or polyester material. However, in alternate embodiments of the present invention, the base can be made from other insulating material and can include different adhesive methods including, but not limited to, magnetic material. As can be seen in FIG. 2, the plurality of solar cells is attached to the front face of the base, and are connected to the power storage unit which is connected to a plurality of wires that connects the plurality of electronic components with the circuit. In the preferred embodiment of the present invention, the plurality of solar cells is glued to the front face of the base in a rectangular pattern along the edge of the base and are placed in a rectangular pattern around the circuit. The plurality of electronic components includes, but is not limited to, resistors, capacitors, etc. However, in alternate embodiments of the present invention, the plurality of solar cells can be attached to the base using different methods such as, but not limited to, soldering, and can be arranged on the front face of the base in different patterns. As can be seen in FIG. 1, the cover is placed on top of the circuit and contains the signage which contains the registration information. In the preferred embodiment of the present invention, the cover adhesively attaches to the base and the cover has an outer insulation to protect the circuit and all the circuit components. The signage is printed on the cover. However, in alternate embodiments of the present invention, the cover can be attached to the base through different means and the signage can be drawn on the cover.

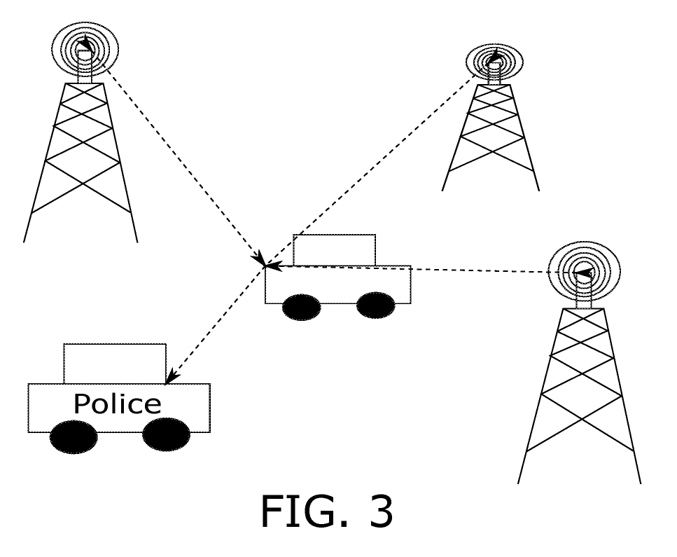

In the preferred embodiment of the present invention, the decal tag comprises a circuit that relates to a radio frequency (RF) circuit comprising an amplifier circuit, oscillators, frequency up-and-down converters and a plurality of other circuits. The RF circuit receives RF signals transmitted from one or more transmitter, as shown in the FIG. 3. In the preferred embodiment of the present invention, the one or more transmitter is cell towers. In alternate embodiments of the present invention, the one or more transmitters can include, but is not limited to, one or more small RF transmitter placed around a city. The one or more transmitter comprises an antenna, a data storage unit, and a plurality of electronic components connected to each other and connected to a power storage unit which is connected to a power source. In alternate embodiments of the present invention, the decal tag can comprise a different long-range data transferring technology. In the preferred embodiment of the present invention, the decal tag can send out signals so authorities and law enforcement agencies can locate the position of the motor vehicle. In the preferred embodiment of the present invention, the law enforcement agencies can approximate the location of the signals sent out from the decal tag through triangulation. In alternate embodiments of the present invention, the law enforcement can approximate the location of the signals sent out from the decal tag through different methods of approximating the position of the decal signal relative to the position of the one or more transmitter. In the preferred embodiment of the present invention the law enforcement methods can locate stolen motor vehicles without the presence of a driver in the motor vehicle. In the preferred embodiment of the present invention, the signals sent out from the decal tag are received by a reader device. In the preferred embodiment of the present invention, the signals sent out from the decal tag and the transmitters are encrypted signals. The reader device comprises a plurality of electronic components connected to a power source and a power storage unit. The plurality of electronic components is connected to a display and a user interface that allows the user to configurated the reader device and control the reader device. The reader device further comprises a software that comprises a decryption code. The encrypted signals are only accessible by authorities and law enforcement agencies that have access to a reader device with the software and decryption code provided by the present invention. The encryption methods include, but are not limited to, symmetric keys and private keys.

In the preferred embodiment of the present invention, a reader device is attached to the dashboard of an authorized law enforcement motor vehicle. In the preferred embodiment of the present invention, the corresponding software is connected to law enforcement agencies databases and the state's department of motor vehicle licensing databases. However, in alternate embodiments of the present invention, the reader device connects to a separate device that connects to law enforcement agencies databases and the state's department of motor vehicle licensing databases. In the preferred embodiment of the present invention, the reader device is a separate device retrofitted to the law enforcement motor vehicle. However, in alternate embodiments of the present invention, the reader device can be part of the law enforcement motor vehicle.

In the preferred embodiment of the present invention, the decal tag can be used to locate a plurality of motor vehicles in transit. Authorities can monitor the location of the different motor vehicles, the amount of motor vehicles in transit, and the movement of the motor vehicles equipped with the present invention to determine the state of the traffic along a street, road, and/or highway. Authorities can employ numerous tactics and methods to alleviate or encourage traffic on streets, road, and/or highways including, but not limited to, deploying law enforcement agents, one or more transit signal, and other apparatuses to guide the traffic flow to different streets, roads, or highways and reduce or limit the traffic flow in congested streets, roads, and/or highways. Furthermore, in alternate embodiments of the present invention, the present invention can be used to collect traffic data which can be potentially used for future infrastructure plans.

Although the invention has been explained in relation to its preferred embodiment, it is to be understood that many other possible modifications and variations can be made without departing from the spirit and scope of the invention.

The invention claimed is:

1. A device comprising of an electronic system that includes GPS for location purposes, notification capabilities and calling capabilities to activate itself and provide location of the vehicle. The device can also self-activate if the license plate is taken off the vehicle.

2. A device according to claim 1, wherein the device will be a decal placed in the top right side of number plate.

3. A device according to claim 1, wherein the device includes a GPS system for determining the location of the vehicle.

4. A device according to claim 1, wherein the device has an activating system that can be turned on when notified by the authorities.

5. A device according to claim 1, wherein the device is not always on to save battery and prevent from tracking, so it will only turn on when law enforcement notifies authorities.

6. A device according to claim 1, wherein the device will be made of a very thin sheet and the same size as the current decal/license plate.

7. A device according to claim 1, wherein once the device is activated by the authorities, it will send a signal to the authorities indicating the exact location of the vehicle.

8. A device according to claim 1, wherein the device will trigger a pulse to local authorities and law enforcement agencies and they will get a notification of the exact GPS coordinates of the vehicle's location.

9. A device according to claim 1, wherein the device will be programmed with decal number and information of the vehicle.

10. A device according to claim 1, wherein each device will be programmed in the system with the specific decal number that already exists on the decal/number plate.
